(19) United States
(12) Patent Application Publication
(10) Pub. No.: US 2013/0135524 A1
(43) Pub. Date: May 30, 2013

(54) METHOD FOR SEARCHING SMALL MOVING OBJECT IN DYNAMIC IMAGE

(71) Applicants: Hsiao-Enmr Chang, Hsinchu City (TW); Tsui-Chin Chen, Hsinchu City (TW); I-Feng Lin, Hsinchu County (TW); Jiande Jiang, Shaanxi Province (CN)

(72) Inventors: Hsiao-Enmr Chang, Hsinchu City (TW); Tsui-Chin Chen, Hsinchu City (TW); I-Feng Lin, Hsinchu County (TW); Jiande Jiang, Shaanxi Province (CN)

(73) Assignee: NOVATEK MICROELECTRONICS CORP., Hsinchu (TW)

(21) Appl. No.: 13/523,894

(22) Filed: Jun. 15, 2012

(30) Foreign Application Priority Data
Nov. 24, 2011 (TW) 100143153

(51) Int. Cl. H04N 7/01

(52) U.S. Cl. 348/441; 348/E07.003

(57) ABSTRACT

A method for searching small moving object is used to insert an inserting image frame between adjacent two image frames. An inserting region is selected in the inserting image frame. Multiple extending directions passing through the inserting region are selected. Each of the extending directions extends and intersects with the two image frames to analyze out which one of the extending directions satisfies the condition of movement by the same object, and obtain at least one motion vector corresponding to the extending direction. A globe motion vector between the two image frames is obtained. A motion-vector difference between the at least one motion vector and the globe motion vector is compared to judge whether greater than a setting value. If the motion vector difference is greater than the setting value then the first local-region image data and the second local-region image data are treated as a small moving object.

### CROSS-REFERENCE TO RELATED APPLICATION

This application claims the priority benefit of Taiwan application serial no. 100143153, filed on Nov. 24, 2011. The entirety of the above-mentioned patent application is hereby incorporated by reference herein and made a part of this specification.

### BACKGROUND OF THE INVENTION

1. Field of the Invention

The present invention generally relates to a method for searching a small moving object in a dynamic image.

2. Description of Related Art

As for the display of a dynamic image, generally, a background image and a foreground image exist. The background image is, for example, a whole image of the environment, and the foreground image is, for example, an image of a small moving object in the environment image. The background image and the foreground image are generally moving.

When shooting the dynamic scene with a video camera, images are captured with a fixed frame rate, that is, 24 image frames are captured every second. The digital images are not consistent with a common play speed, for example, a play speed of 60 frames every second. Therefore, in order to match the image play mode, another frame needs to be inserted between two frames. However, the small moving object occupies a small area, and generally has a moving direction different from the moving direction of the background, so when inserting the frame, the small moving object may disappear or may be incorrect.

How to find the small moving object more correctly is one of factors to be considered for improving the image quality.

### SUMMARY OF THE INVENTION

The present invention is directed to a method for searching a small moving object in a dynamic image, which may correctly search for the small moving object in the dynamic image when inserting an image.

The present invention provides a method for searching a small moving object in a dynamic image, which is used to insert an inserting image plane between a first image plane and a second image plane. The method includes the following steps. An inserting region in the inserting image plane is selected. Multiple extending directions are constructed in multiple local regions in a predetermined range and a reference region by taking a position of the inserting region as the reference region, the extending directions respectively intersect with the first image plane and the second image plane to obtain multiple pairs of local-region image data, where each pair of the local-region image data includes a first local-region image data of the first image plane and a second local-region image data of the second image plane. A difference between the first local-region image data and the second local-region image data of each pair of the local-region image data is calculated, where when the difference is smaller than a setting value, the corresponding extending direction is considered as at least one primary motion vector. A globe motion vector between the first image plane and the second image plane is obtained. A motion vector difference between the at least one motion vector and the globe motion vector is compared with a setting value to see whether the motion vector difference is greater than the setting value, where if the motion vector difference is greater than the setting value, the first local-region image data and the second local-region image data of the corresponding extending direction are recognized as an image of a small moving object.

According to an embodiment of the present invention, the method may further include a confirmation step. The confirmation step includes the following steps. A first small moving object from the first image plane to the second image plane is found, and a first motion vector is obtained. A second small moving object from the second image plane to the first image plane is found, and a second motion vector is obtained. It is detected whether the first motion vector and the second motion vector are substantially consistent; and if the first motion vector and the second motion vector are substantially consistent, it is detected whether the first motion vector or the second motion vector is substantially consistent with the motion vector corresponding to the small moving object, and the small moving object is discarded if the first motion vector or the second motion vector is not consistent with the motion vector corresponding to the small moving object.

According to an embodiment of the present invention, the method further includes a confirmation step. The confirmation step includes the following steps. A first small moving object from the small moving object recognized in the first image plane to the second image plane is found, and a first motion vector is obtained. A second small moving object from the small moving object recognized in the second image plane to the first image plane is found, and a second motion vector is obtained. It is detected whether the first motion vector and the second motion vector are substantially consistent; and if the first motion vector and the second motion vector are substantially consistent, it is detected whether the first motion vector or the second motion vector is substantially consistent with the motion vector corresponding to the small moving object, and the small moving object is discarded if the first motion vector or the second motion vector is not consistent with the motion vector corresponding to the small moving object.

The present invention further provides a method for searching a small moving object in a dynamic image, which is used to insert an inserting image frame between a first image frame and a second image frame adjacent in display data of a dynamic image. The method includes the following steps. An inserting region in the inserting image frame is selected. Multiple predetermined extending directions passing through the inserting region are selected. The extending directions respectively intersect with the first image frame and the second image frame simultaneously to obtain a first local-region image data and a second local-region image data, it is analyzed whether the extending directions meet a condition of the same image object moving, and at least one motion vector is obtained with the corresponding extending direction. A globe motion vector between the first image frame and the second image frame is obtained. A motion vector difference between the at least one, motion vector and the globe motion vector is compared with a setting value to see whether the motion vector difference is greater than the setting value, where if the motion vector difference is greater than the setting value, the corresponding first local-region image data and the second local-region image data are considered as a small moving object.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of solving a problem of two image frames according to the present invention.

FIG. 2 is a schematic view of moving changes of a foreground image and a background image on a time axis corresponding to FIG. 1.

FIG. 3 is a schematic view of a mechanism for finding a small moving object when inserting an image frame according to an embodiment of the present invention.

FIG. 4 is a schematic flow chart of a method for searching a small moving object in a dynamic image according to an embodiment of the present invention.

FIG. 5 is a schematic view of a mechanism for finding a small moving object according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

As for a shot digital dynamic image, content of a previous image frame is not consistent with content of a next image frame, and a moving object exists.

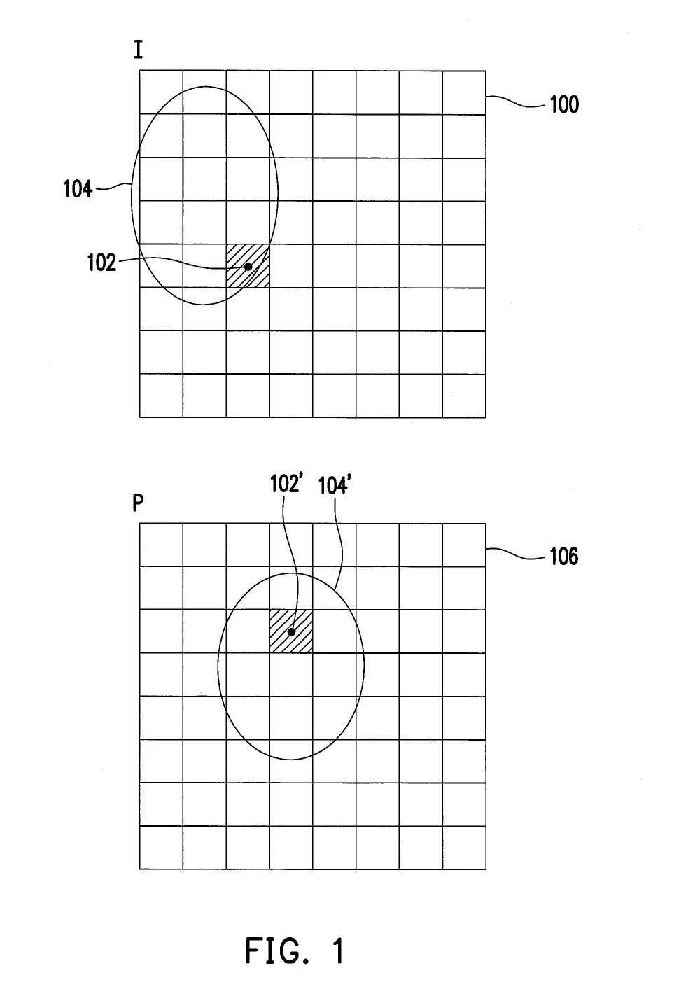

FIG. 1 is a schematic view of solving a problem of two image frames according to the present invention. Referring to FIG. 1, an image frame 100, also referred to as a frame I, is shot image data, which is an image picture displayed with respect to a time point. In the image picture, a plurality of pixels form a pixel array, and the pixel array may further be, for example, divided into blocks for being analyzed and processed, which depends on the actual arrangement.

A current image frame 106, also referred to as a frame P, is current image data closely following the previous image frame 100, and is also an image picture. Content of the image frame 100 is generally divided into a background image 104 and a foreground image 102. The foreground image 102 may be a small moving object. The background image 104 is an image of an environment scene. Generally speaking, the background image 104 occupies the most part of the image, and may have some movement. The foreground image 102 is a small object having small movement, and has a moving direction generally different from a moving direction of the background image 104. In the image frame 106, due to the movement, the foreground image 102′ may also have movement, and at the same time, the background image 104′ may also have movement. Definitely, the background image 104′ may also be static.

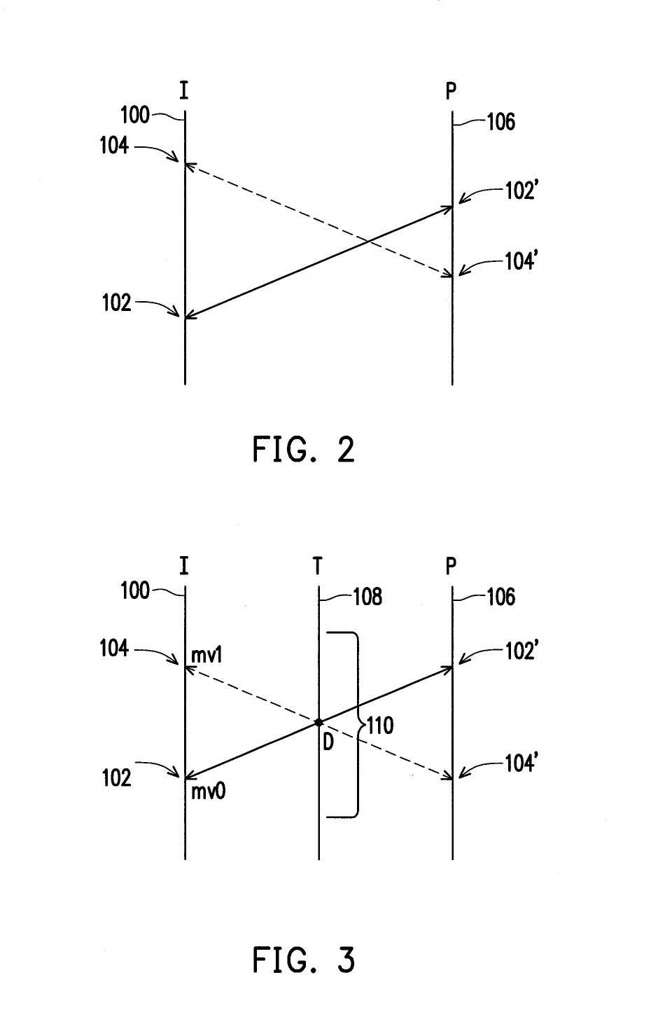

FIG. 2 is a schematic view of moving changes of a foreground image and a background image on a time axis corresponding to FIG. 1. Referring to FIG. 2, the image frame 100 has the background image 104 and the foreground image 102. If the background image 104 and the foreground image 102 are both moving, generally, they move in different directions. Therefore, in an image frame 106 shot after a time period of one hour, the foreground image 102 moves to the foreground image 102′, and the background image 104 moves to the foreground image 104′. The changing extent of the moving is generate represented by a motion vector (MV), which represents an amount of movement and a direction of the same object moving from the image frame 100 to the image frame 106. The motion vector is a common parameter well-known by persons skilled in the art, and the details are not described further.

FIG. 3 is a schematic view of a mechanism for finding a small moving object when inserting an image frame according to an embodiment of the present invention. Referring to FIG. 3, a frame rate for actual shooting is generally smaller than a frame rate for playing, and therefore, for example another image frame 108, also referred to as a frame T, needs to be inserted between two adjacent image frames 100, 106 that are actually shot. For example, the frame T is inserted at a middle time point.

As for image recognition, a manner of determining whether the image frame 100 and the image frame 106 have the same image content adopts, for example, a commonly known sum of absolute difference (SAD), which is a sum of all absolute differences of pixel values between an image block of the image frame 100 and an image block having the same shape in the image frame 106.

Ideally, if the detected image blocks have the same content, the image blocks are coincide with each other, and therefore, the SAD value approaches to 0. In other words, if the SAD value is smaller than an extent, it indicates that the image blocks detected in the image frame 100 and in the image frame 106 may be considered as the same object, and therefore, a motion vector thereof may be calculated.

An inserting region D to be inserted in the image frame 108 needs data of the image frame 100 and the image frame 106 to perform the insertion, and therefore, corresponding identical local-region images need to be found. Corresponding to a position of the inserting region D, an image passing through the inserting region D from the image frame 100 to image frame 106 may further include an image of the foreground image 102 in addition to an image of the background image 104, and the image of the foreground image 102 is, for example, an image of a small moving object.

The local-region images belonging to the foreground image 102 and the background image 104 have SAD values thereof all smaller than a selected setting value, but have different motion vectors. Incorrect selection of the motion vector may cause the possibility of disappearance of the small object.

The present invention proposes a method for effectively detecting the moving of the small object, so as to at least reduce the possibility of the disappearance of the small object.

By using a position of the inserting region D as a reference, multiple extending directions may be selected to intersect with the image frame 100 and the image frame 106 respectively, so as to obtain respective local-region images. It may be judged whether the local-region images belong to the same image content according to the SAD value of each of the extending directions, and a motion vector may also be obtained at the same time. A pair of local-region images includes a local-region image in the image frame 100, corresponding to a label 102 or 104, and a local-region image in the image frame 106, corresponding to a label 102′ or 104′.

The local-region image corresponding to the background image 104 and passing through the inserting region D may have a motion vector mv1 from the image frame 100 to the image frame 106 or from the image frame 106 to the image frame 100. If the foreground image 102 having the small moving object also passes through the inserting region D, the foreground image 102 having the small moving object may generate a small SAD value and thus being selected, and may also have a motion vector mv0.

The image frame 100, the image frame 106, and the image frame 108 are display pictures of the same size in the displayed image plane, and therefore, the extending directions passing through the inserting region D may be converted, on the image plane, into related positions of the inserting region D. In other words, a range for finding the possible small moving object may take the inserting region D as a reference, within a set local-region 110 nearby, and a finding density depends on the processing capability.

Then, the small moving object is distinguished by comparing with a globe motion vector. As for the situation from the image frame 100 to the image frame 106, the small moving object occupies a small part of the display area, and therefore, a globe motion vector obtained through statistics still represents a moving extent approaching to the background image. The moving direction of the small moving object is basically different with a moving direction of the background image. Therefore, the obtained motion vector belonging to the same object is compared with a globe motion vector, and if a difference between the motion vector and the globe motion vector is greater than a setting extent, it may be determined that the motion vector is generated by the small moving object. Therefore, when inserting the image of the inserting region D, the image of the small moving object should be taken into consideration, thereby reducing the possibility of the disappearance of the small moving object. In addition, if no small moving object is found, it is unnecessary to consider, for the inserting region D, whether the small moving object exists.

When the small moving object exists, confirmation may further be made. The manner of making the confirmation includes: finding a small moving object directly from the image frame 100 to the image frame 106 and calculating a motion vector, and finding a small moving object directly from the image frame 100 to the image frame 106 and calculating a motion vector. The motion vectors found in the two directions should be consistent.

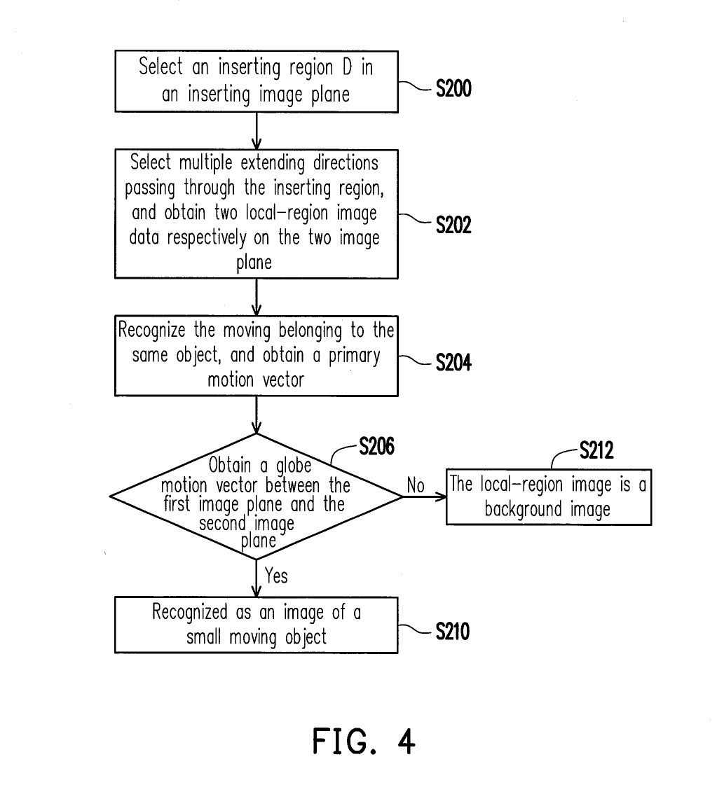

The mechanism in FIG. 3 may be divided into several steps. FIG. 4 is a schematic flowchart of a method for searching a small moving object in a dynamic image according to an embodiment of the present invention.

Referring to FIG. 4, the method for searching a small moving object may be used to insert an inserting image plane between a first image plane and a second image plane. In step S200, an inserting region D in the inserting image plane is selected. In step S202, multiple extending directions are constructed in multiple local regions in a predetermined range and a reference region by taking a position of the inserting region as the reference region, and the extending directions respectively intersect with the first image plane and the second image plane to obtain multiple pairs of local-region image data. Each pair of the local-region image data includes a first local-region image data of the first image plane and a second local-region image data of the second image plane.

In step S204, a difference between the first local-region image data and the second local-region image data of each pair of the local-region image data is calculated, where when the difference is smaller than a setting value, the corresponding extending direction is considered as at least one primary motion vector. In step S206, a globe motion vector between the first image plane and the second image plane is obtained.

In step S208, a motion vector difference between the at least one motion vector and the globe motion vector is compared with a setting value to see whether the motion vector difference is greater than the setting value. In step S210, if the motion vector difference is greater than the setting value, the first local-region image data and the second local-region image data of the corresponding extending direction are recognized as an image of a small moving object. In step S212, if the motion vector difference is not greater than the setting value, the local-region image is a background image.

Theoretically, if the image frame I and the image frame P actually include the small moving object, the corresponding local-region images may be found. Therefore, repeated confirmation may be performed if required.

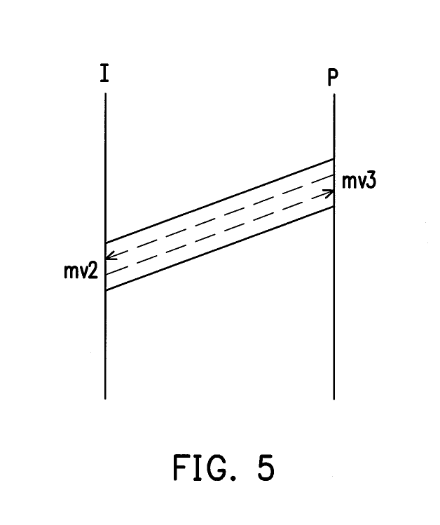

FIG. 5 is a schematic view of a mechanism for finding a small moving object according to an embodiment of the present invention. Referring to FIG. 5, the method for determining whether the found small moving object is correct includes the following steps. A small moving object from the image frame Ito the image frame P is found, and a first motion vector mv2 is obtained. A small moving object from the image frame P to the image frame I is found, and a second motion vector mv3 is obtained. If the motion vector my and the motion vector mv3 are substantially consistent and are different from the globe motion vector, it is determined that the small moving object is found. That is to say, if the motion vectors of the small moving objects found from the two image frames in two directions are substantially consistent with the motion vector mv0 of the small moving object in FIG. 3, it is confirmed that the small moving object is found. If the motion vectors are not consistent, the small moving object is discarded.

In another confirmation manner, a first small moving object is found from the small moving object recognized by FIG. 3 in the image frame I to the image frame P, and a first motion vector mv2 is obtained. A second small moving object is found from the small moving object recognized by FIG. 3 in the image frame P to the image frame I, and a second motion vector is obtained. It is detected whether the first motion vector and the second motion vector are substantially consistent. If the first motion vector and the second motion vector are substantially consistent, it is detected whether the first motion vector or the second motion vector is substantially consistent with the motion vector mv0 of the small moving object correspondingly detected by FIG. 3. The detected small moving object is discarded if any inconsistent exists.

From another viewpoint, a method for searching a small moving object in a dynamic image may be used to insert an inserting image frame between a first image frame and a second image frame adjacent in display data of a dynamic image. The method includes the following steps. An inserting region in the inserting image frame is selected. Multiple predetermined extending directions passing through the inserting region are selected. The extending directions respectively intersect with the first image frame and the second image frame simultaneously to obtain a first local-region image data and a second local-region image data, it is analyzed whether the extending directions meet a condition of the same image object moving, and at least one motion vector is obtained with the corresponding extending direction. A globe motion vector between the first image frame and the second image frame is obtained. A motion vector difference between the at least one motion vector and the globe motion vector is compared with a setting value to see whether the motion vector difference is greater than the setting value, where if the motion vector difference is greater than the setting value, the corresponding first local-region image data and the second local-region image data are considered as a small moving object.

In order to complete all image data of the inserting image, the position of the inserting region may be changed according to the same mechanism, so that all local-regions of the inserting image are inserted in the image data.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for searching a small moving object in a dynamic image, for inserting an inserting image plane between a first image plane and a second image plane, comprising:
selecting an inserting region in the inserting image plane;
constructing multiple extending directions in multiple local regions in a predetermined range and a reference region by taking a position of the inserting region as the reference region, intersecting the extending directions respectively with the first image plane and the second image plane to obtain multiple pairs of local-region image data, each pair of the local-region image data comprises a first local-region image data of the first image plane and a second local-region image data of the second image plane;
calculating a difference between the first local-region image data and the second local-region image data of each pair of the local-region image data, wherein when the difference is smaller than a setting value, the corresponding extending direction is considered as at least one primary motion vector;
obtaining a globe motion vector between the first image plane and the second image plane; and
comparing a motion vector difference between the at least one motion vector and the globe motion vector and a setting value to see whether the motion vector difference is greater than the setting value, wherein if the motion vector difference is greater than the setting value, the first local-region image data and the second local-region image data of the corresponding extending direction are recognized as an image of a small moving object.

2. The method for searching a small moving object in a dynamic image according to claim 1, further comprising a confirmation step, wherein the confirmation step comprises:
finding a first small moving object from the first image plane to the second image plane, and obtaining a first motion vector;
finding a second small moving object from the second image plane to the first image plane, and obtaining a second motion vector;
detecting whether the first motion vector and the second motion vector are substantially consistent; and
if the first motion vector and the second motion vector are substantially consistent, detecting whether the first motion vector or the second motion vector is substantially consistent with the motion vector corresponding to the small moving object, and discarding the small moving object if the first motion vector or the second motion vector is not consistent with the motion vector corresponding to the small moving object.

3. The method for searching a small moving object in a dynamic image according to claim 1, further comprising a confirmation step, wherein the confirmation step comprises:
finding a first small moving object from the small moving object recognized in the first image plane to the second image plane, and obtaining a first motion vector;
finding a second small moving object from the small moving object recognized in the second image plane to the first image plane, and obtaining a second motion vector;
detecting whether the first motion vector and the second motion vector are substantially consistent; and
if the first motion vector and the second motion vector are substantially consistent, detecting whether the first motion vector or the second motion vector is substantially consistent with the motion vector corresponding to the small moving object, and discarding the small moving object if the first motion vector or the second motion vector is not consistent with the motion vector corresponding to the small moving object.

4. The method for searching a small moving object in a dynamic image according to claim 1, wherein the difference between the first local-region image data and the second local-region image data is a sum of absolute difference (SAD) of pixels.

5. The method for searching a small moving object in a dynamic image according to claim 1, wherein the inserting region comprises multiple pixels.

6. The method for searching a small moving object in a dynamic image according to claim 1, wherein the first image plane and the second image plane are adjacent two frames of a dynamic image, and the inserting image plane is an inserting frame to be inserted between the two frames.

7. The method for searching a small moving object in a dynamic image according to claim 1, wherein the inserting region moves in a whole local-region of the inserting image plane to complete an imager insertion of the whole local-region.

8. The method for searching a small moving object in a dynamic image according to claim 1, wherein the inserting image data of the inserting region is performing image insertion according to a value of the motion vector.

9. A method for searching a small moving object in a dynamic image, for inserting an inserting image frame between a first image frame and a second image frame adjacent to each other in display data of a dynamic image, comprising:
selecting an inserting region in the inserting image frame;
selecting multiple predetermined extending directions passing through the inserting region;
respectively intersecting the extending directions with the first image frame and the second image frame simultaneously to obtain a first local-region image data and a second local-region image data, analyzing whether the extending directions meet a condition of the same image object moving, and obtaining at least one motion vector with the corresponding extending direction;
obtaining a globe motion vector between the first image frame and the second image frame; and
comparing a motion vector difference between the at least one motion vector and the globe motion vector with a setting value to see whether the motion vector difference is greater than the setting value, wherein if the motion vector difference is greater than the setting value, the corresponding first local-region image data and the second local-region image data are considered as a small moving object.

10. The method for searching a small moving object in a dynamic image according to claim 9, further comprising a confirmation step, wherein the confirmation step comprises:
finding a possible first small moving object from the first image frame to the second image frame, and obtaining a first motion vector;
finding a possible second small moving object from the second image frame to the first image frame, and obtaining a second motion vector;
detecting whether the first motion vector and the second motion vector are substantially consistent; and
if the first motion vector, the second motion vector, and the motion vector corresponding to the small moving object are not consistent, discarding the recognition of the small moving object.

11. The method for searching a small moving object in a dynamic image according to claim 9, wherein the difference between the first local-region image data and the second local-region image data is a sum of absolute difference (SAD) of pixels.

12. The method for searching a small moving object in a dynamic image according to claim 9, further comprising a confirmation step, wherein the confirmation step comprises:
finding a first small moving object from the small moving object recognized in the first image plane to the second image plane, and obtaining a first motion vector;
finding a second small moving object from the small moving object recognized in the second image plane to the first image plane, and obtaining a second motion vector;
detecting whether the first motion vector and the second motion vector are substantially consistent; and
if the first motion vector and the second motion vector are substantially consistent, detecting whether the first motion vector or the second motion vector is substantially consistent with the motion vector corresponding to the small moving object, and discarding the small moving object if the first motion vector or the second motion vector is not consistent with the motion vector corresponding to the small moving object.
